(19) United States
(12) Patent Application Publication
(10) Pub. No.: US 2010/0108831 A1
(43) Pub. Date: May 6, 2010

(54) CURLING IRON SHIELD AND STAND COMBINATION

(76) Inventor: ANTHONY KIT LUN LEUNG, North Point (HK)

Correspondence Address: Lawrence Cruz;Conair Corporation, One Cummings Point Road, STAMFORD, CT, 06902, US

(21) Appl. No.: 12/261,212

(22) Filed: Oct. 30, 2008

(51) Int. Cl. F16M 11/00

(52) U.S. Cl. 248/176.2

(57) ABSTRACT

A curling iron stand 1 comprises a generally cylindrical tube 2 made of insulated material, an open receiving end 3 adapted to receive a cylindrical barrel of a curling iron, and a pair of pivotably mounted legs 4, 5. The legs 4, 5 pivot between a standing position in which they form a tripod, in cooperation with the tube 2, and a folded position in which the legs 4, 5 are pivoted into parallel alignment with a longitudinal axis of the tube 2. In the folded position, a tab 6, 7 attached to a pivot section 8, 9 of each leg swings into place to lock a curling iron that is held in the tube 2 so that it cannot slide out, to prevent accidental release of the curling iron from the tube. In the standing position, the stand 1 can rest on a table or countertop and be used to place a curling iron into it and remove it conveniently and safely.

### CROSS-REFERENCE TO RELATED APPLICATIONS

None.

### BACKGROUND OF THE INVENTION

The present invention relates to hair care appliances and, more particularly, to holders and shields for heated hair appliances.

### DESCRIPTION OF RELATED ART

Heated curling irons for styling hair comprise a handle and a heated barrel that extends from the handle. External electric energy is used to activate a heat element running through the barrel to heat the barrel and transmit heat to hair when the barrel is applied against hair. Various stands and holders exist for receiving and insulating the heated barrel when a user sets a curling iron down on a stand or in a receptacle while it is heated. Some stands lay flat, while others have dedicated legs in, for example, tripod configuration, to hold the iron on a table with the handle end raised and ready to be grasped. Each is dedicated to its configuration and is not variable in configuration. Also, in the event of disrupting the stand or the surface on which it is rested, there is danger that the curling iron could slide out and the heated barrel may inadvertently contact an object or a person.

### OBJECT OF THE PRESENT INVENTION

It is an object of the present invention to provide a curling iron stand having a heat insulated shield for the barrel of a curling iron, a pair of legs that are adjustable to permit the stand to lay flat or to stand up in tripod manner in which the shield forms the third leg, and a means for selectively locking and unlocking a curling iron in the stand.

These an other objects are achieved by the present invention disclosed herein.

### SUMMARY OF THE INVENTION

According to the present invention, a curling iron stand comprises a generally cylindrical tube made of insulated material, an open receiving end adapted to receive a barrel of a curling iron, and a pair of pivotably mounted legs. The legs pivot between a standing position in which they form a tripod, in cooperation with the tube, and a folded position in which the legs are pivoted into parallel alignment with a longitudinal axis of the tube. In the folded position, a tab attached to a pivot section of each leg swings into place to lock a curling iron that is held in the tube so that it cannot slide out, to prevent accidental release of the curling iron from the tube.

### BRIEF DESCRIPTION OF THE DRAWINGS

FIG. 1 is a top view of a preferred embodiment of the present invention.

FIG. 2 is a side view of a preferred embodiment of the present invention.

FIG. 3 is a bottom view of a preferred embodiment of the present invention.

FIG. 4 is a rear view of a preferred embodiment of the present invention.

FIG. 5 is a front view of a preferred embodiment of the present invention.

FIG. 6 is a perspective view of a preferred embodiment of the present invention.

FIG. 7 is a top view of a preferred embodiment of the present invention shown with its legs extended.

FIG. 8 is a side view of a preferred embodiment of the present invention shown with its legs extended.

FIG. 9 is a bottom view of a preferred embodiment of the present invention shown with its legs extended.

FIG. 10 is a rear view of a preferred embodiment of the present invention shown with its legs extended.

FIG. 11 is a perspective view of a preferred embodiment of the present invention shown with its legs extended.

FIG. 12 is a front view of a preferred embodiment of the present invention shown with its legs extended.

FIG. 13 is a perspective, exploded view of a preferred embodiment of the present invention shown with its legs extended.

FIG. 14 is a perspective, partial view of a component of a preferred embodiment of the present invention.

FIG. 15 is a perspective, partial view of a component of a preferred embodiment of the present invention.

### DESCRIPTION OF THE PREFERRED EMBODIMENT OF THE PRESENT INVENTION

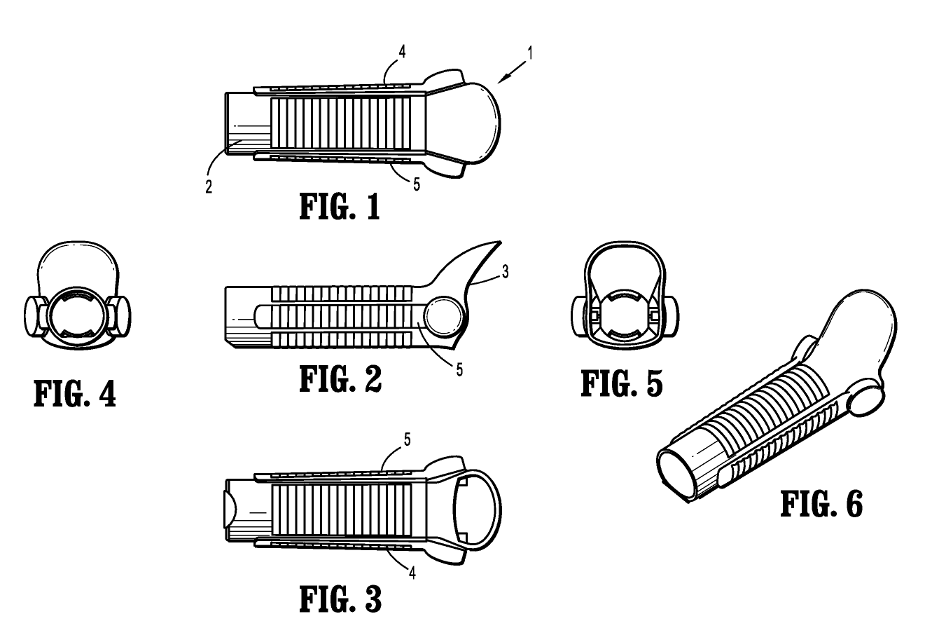

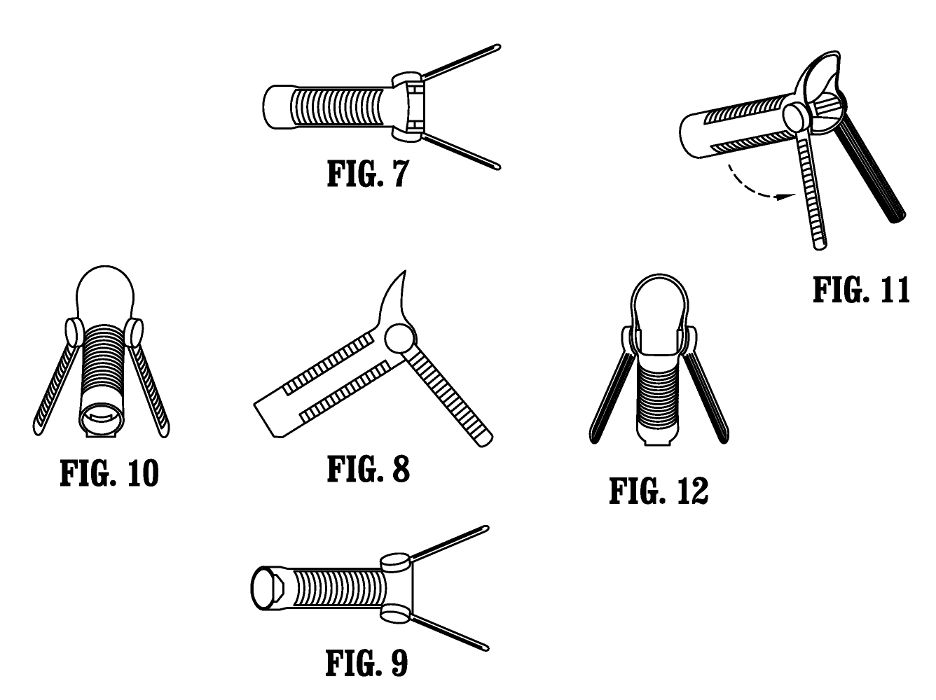

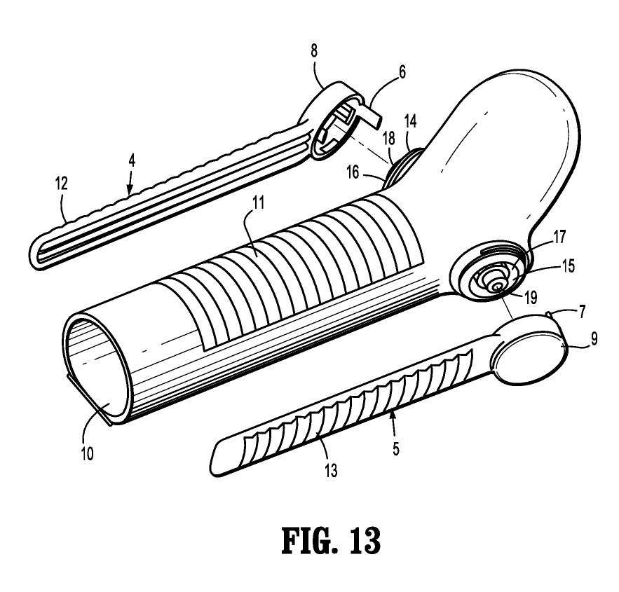

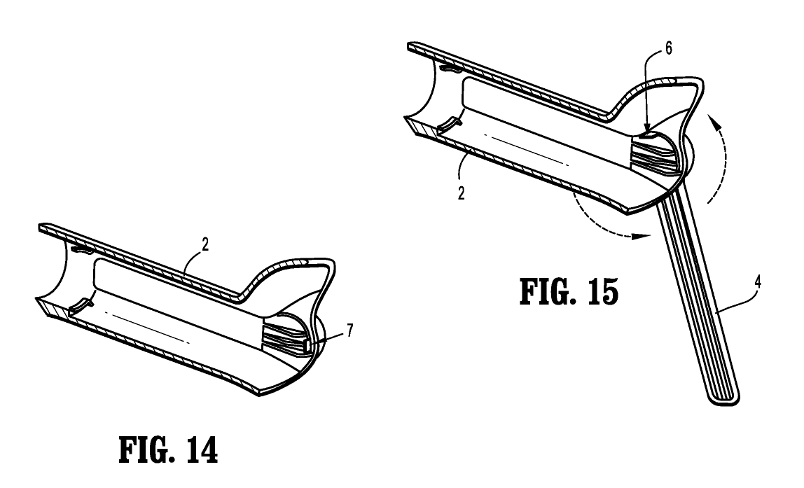

Referring to FIGS. 1-15, a curling iron stand 1 comprises a generally cylindrical tube 2 made of insulated material, an open receiving end 3 adapted to receive a cylindrical barrel of a curling iron (not shown), and a pair of pivotably mounted legs 4, 5. The legs 4, 5 pivot between a standing position (see FIGS. 7-12) in which they form a tripod, in cooperation with the tube 2, and a folded position (see FIGS. 1-6) in which the legs 4, 5 are pivoted into parallel alignment with a longitudinal axis of the tube 2. In the folded position, a tab 6, 7 attached to a pivot section 8, 9 of each leg swings into place to lock a curling iron that is held in the tube 2 so that it cannot slide out, to prevent accidental release of the curling iron from the tube. In the standing position, the stand 1 can rest on a table or countertop and be used to place a curling iron into it and remove it conveniently and safely.

The tube 2 may be made of a plastics or other insulated materials, including laminates or composites including metals, that have sufficient rigidity and insulation properties to support and insulate the heated barrel of a curling iron. The length of the tube 2 should be sized to be longer than the curling iron barrel or barrels with which it will be used. Preferably, the distal end 10 of the tube 2 is opened to permit heat escape and to prevent heat build up. The exterior surface of the tube 2 may have ridges 11 formed thereon to facilitate gripping and to dissipate heat. Similarly, the legs 4, 5 may have ridges 12, 13 formed on their respective exterior surfaces.

The pivot sections 8, 9 of the legs 4, 5 are round hubs that are adapted to be fit into corresponding round holes 14, 15 formed on the tube 2 with respective cylindrical walls 16,17 and axle bosses 18, 19, in order to receive the pivot sections 8, 9 in pivoting relationship relative to the tube 2. The pivot connections formed by the foregoing elements may include ratchet teeth or similar mechanisms to selectively index and lock the legs in various positions, and to release them.

Each tab 6, 7 swings into a position in which the tabs 6, 7 are generally diametrically opposed to each other across the open receiving end 3 of the tube 2 when the legs 4, 5 are in the folded position. The tabs 6, 7 are sized so that when in the folded position, the tabs create an inner diameter that is larger than the handle of the curling iron diameter held therebetween but less than the diameter of a collar that separates the curling iron handle from the curling iron barrel. This enables the curling iron to become trapped in the tube when the legs 4, 5 are folded because the collar is positioned between the tabs 6, 7 and the distal end 10 before folding the legs 4, 5. When the legs 4, 5 are in the standing position, the tabs 6, 7 are pivoted to the side of the opening 3 and are not diametrically opposed over the opening 3. Instead, they are opposed to each other at the side of the opening 3, rather than across it.

While the preferred embodiment of the present invention has been disclosed herein, it is understood that various modification can be made without departing from the scope of the presently claimed invention.

What is claimed is:

1. A curling iron holder and stand for holding a curling iron of the type having a cylindrical barrel, said holder and stand comprising
a generally cylindrical tube having an open receiving end adapted to receive a cylindrical barrel of a curling iron; and
a pair of legs pivotably mounted to the tube and each leg adapted to pivot between a standing position in which the legs form a tripod in cooperation with the tube, and a folded position in which the legs are pivoted into parallel alignment with a longitudinal axis of the tube.

2. A holder and stand according to claim 1, further comprising
a pair of tabs, each tab being attached to a respective one of said pair of legs at a respective pivot section of each leg, such that each said tab swings into a position in which the tabs are generally diametrically opposed to each other across the open receiving end of the tube when the legs are in said folded position.

3. A holder and stand according to claim 2, wherein
when each said tab swings into a position in which the tabs are positioned to the side of the open receiving end of the tube when the legs are in said standing position.

4. A holder and stand according to claim 2, wherein
said tube is made of a thermally insulated material.

5. A holder and stand according to claim 2, wherein
said tube has an open distal end located opposite said open receiving end.

6. A holder and stand according to claim 2, wherein
said tube has a plurality of ridges formed on its exterior surface.

7. A holder and stand according to claim 2, wherein
said legs each have a plurality or ridges formed on its respective exterior surface.
